(19) United States
(12) Patent Application Publication
(10) Pub. No.: US 2025/0166261 A1
(43) Pub. Date: May 22, 2025

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventor: Yuka OGINO, Tokyo (JP)

(73) Assignee: NEC Corporation, Minato-ku, Tokyo (JP)

(21) Appl. No.: 18/841,708

(22) PCT Filed: Mar. 17, 2022
(86) PCT No.: PCT/JP2022/012166

§ 371 Date: Aug. 27, 2024

(51) Int. Cl. G06T 11/60; G06F 9/451

(52) U.S. Cl. CPC G06T 11/60; G06F 9/451

(57) ABSTRACT

The information processing apparatus includes: a configuration information acquisition unit that acquires object configuration information including a definition of each of one or more elements added to an image in order to indicate an object included in the image and a definition of order of the element; a user interface unit that provides a user interface being set based on a definition of the element indicated by the object configuration information according to order of the element defined by the object configuration information, in order to accept an input for specifying the element with respect to the object; and a storage control unit that controls in such a way as to store information of the element specified by the input in association with the image.

### TECHNICAL FIELD

The present disclosure relates to an information processing apparatus, an information processing system, an information processing method, and a non-transitory computer-readable medium. In particular, the present disclosure relates to an information processing apparatus, an information processing system, an information processing method, and a non-transitory computer-readable medium for performing work of giving an annotation to an image by a user.

### BACKGROUND ART

In recent years, use of a machine learning model has been performed in various technical fields including a technical field related to authentication such as iris authentication and face authentication. Teacher data are used for learning of the machine learning model. When learning of the machine learning model is performed by using image data as teacher data, it is necessary to prepare the teacher data in which annotation information is added to the image data. Note that, in the present disclosure, the annotation information is metadata added to the image data. In other words, the annotation information is supplementary information for representing a content of the image data. In this regard, for example, Patent Literature 1 discloses the following technique.

Patent Literature 1 discloses an apparatus that generates teacher data by acquiring character information, generating a character image including a figure associated to the acquired character information, and adding the acquired character information to the generated character image as annotation information. As a result, it becomes possible to efficiently generate teacher data used for learning of a machine learning model for reading a license plate of an automobile captured by a camera.

### CITATION LIST

### Patent Literature

Patent Literature 1: Japanese Unexamined Patent Application Publication No. 2021-170213

### SUMMARY OF INVENTION

### Technical Problem

In general, when annotation information is added to image data, a user (operator) who views a displayed image performs an operation of specifying annotation information to be added to the image on software, and thereby teacher data are generated.

However, since an amount of teacher data used for learning of a machine learning model is enormous, the more an operation spent for giving annotation information to one image, the more an amount of work for preparing a sufficient amount of teacher data required for learning.

In contrast, in the technique disclosed in Patent Literature 1, it is a technique that automatically generates an image, based on input character information, and uses the generated character information as annotation information. For this reason, the technique does not support an efficient operation by a user for adding annotation information to an image.

Thus, one of objects to be achieved by example embodiments disclosed in the present specification is to provide an information processing apparatus, an information processing system, an information processing method, and a program that enable a user to efficiently add annotation information to an image.

### Solution to Problem

An information processing apparatus according to a first aspect of the present disclosure includes:
a configuration information acquisition means for acquiring object configuration information including a definition of each of one or more elements added to an image in order to indicate an object included in the image and a definition of order of the element;
a user interface means for providing a user interface being set based on a definition of the element indicated by the object configuration information according to order of the element defined by the object configuration information, in order to accept an input for specifying the element with respect to the object; and
a storage control means for controlling in such a way as to store information of the element specified by the input in association with the image.

An information processing system according to a second aspect of the present disclosure includes:
an information processing apparatus; and
a terminal apparatus, wherein
the information processing apparatus includes
a configuration information acquisition means for acquiring object configuration information including a definition of each of one or more elements added to an image in order to indicate an object included in the image and a definition of order of the element,
a user interface means for providing a user interface being set based on a definition of the elements indicated by the object configuration information according to order of the element defined by the object configuration information, in order to accept an input for specifying the element with respect to the object, and
a storage control means for controlling in such a way as to store information of the element specified by the input in association with the image, and
the terminal apparatus includes
an output control means for outputting the user interface provided from the information processing apparatus to an output apparatus, and
an input acceptance means for accept an input to the user interface.

An information processing method according to a third aspect of the present disclosure includes:
acquiring object configuration information including a definition of each of one or more elements added to an image in order to indicate an object included in the image and a definition of order of the element;
providing a user interface being set based on a definition of the element indicated by the object configuration information according to order of the element defined by the object configuration information, in order to accept an input for specifying the element with respect to the object; and
controlling in such a way as to store information of the element specified by the input in association with the image.

A program according to a fourth aspect of the present disclosure causes a computer to execute:
a configuration information acquisition step of acquiring object configuration information including a definition of each of one or more elements added to an image in order to indicate an object included in the image and a definition of order of the element;
a user interface step of providing a user interface being set based on a definition of the element indicated by the object configuration information according to order of the element defined by the object configuration information, in order to accept an input for specifying the element with respect to the object; and
a storage control step of controlling in such a way as to store information of the element specified by the input in association with the image.

### BRIEF DESCRIPTION OF DRAWINGS

FIG. 1 is a block diagram illustrating one example of a configuration of an information processing apparatus according to an outline of an example embodiment;

FIG. 2 is a schematic diagram illustrating an example of annotation information with respect to an object included in an image;

FIG. 3 is a schematic diagram illustrating an example of annotation information in a case where an entire image is considered as one object;

FIG. 4 is a block diagram illustrating one example of a functional configuration of an information processing apparatus according to a first example embodiment;

FIG. 5 is a block diagram illustrating one example of a hardware configuration of the information processing apparatus according to the first example embodiment;

FIG. 6 is a flowchart illustrating one example of operation of the information processing apparatus according to the first example embodiment;

FIG. 7 is a schematic diagram illustrating an example of a screen of a user interface displayed on an output apparatus by a user interface unit;

FIG. 8 is a schematic diagram illustrating an example of guide information displayed on the output apparatus by the user interface unit;

FIG. 9 is a schematic diagram illustrating an example of a screen of a user interface displayed on the output apparatus by the user interface unit;

FIG. 10 is a schematic diagram illustrating an example of a screen of a user interface displayed on the output apparatus by the user interface unit;

FIG. 11 is a schematic diagram illustrating an example of a screen of a user interface displayed on the output apparatus by the user interface unit;

FIG. 12 is a schematic diagram illustrating an example of a screen of a user interface displayed on the output apparatus by the user interface unit;

FIG. 13 is a block diagram illustrating one example of a functional configuration of an information processing apparatus according to a second example embodiment;

FIG. 14 is a flowchart illustrating one example of operation of the information processing apparatus according to the second example embodiment;

FIG. 15 is a block diagram illustrating one example of a functional configuration of an information processing apparatus according to a third example embodiment;

FIG. 16 is a flowchart illustrating one example of operation of the information processing apparatus according to the third example embodiment;

FIG. 17 is a block diagram illustrating one example of a configuration of an information processing system according to a fourth example embodiment;

FIG. 18 is a block diagram illustrating one example of a functional configuration of a terminal apparatus according to the fourth example embodiment;

FIG. 19 is a block diagram illustrating one example of a hardware configuration of an information processing apparatus according to the fourth example embodiment; and

FIG. 20 is a block diagram illustrating one example of a hardware configuration of the terminal apparatus according to the fourth example embodiment.

### EXAMPLE EMBODIMENT

### Outline of Example Embodiment

First, an outline of an example embodiment will be described.

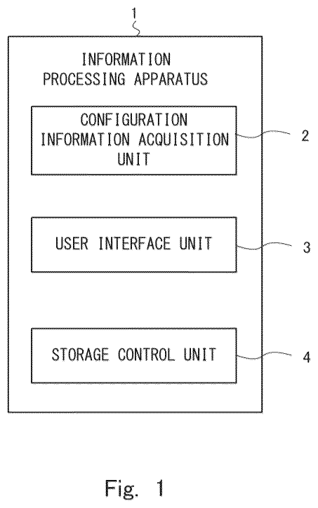

FIG. 1 is a block diagram illustrating one example of a configuration of an information processing apparatus 1 according to the outline of the example embodiment. As illustrated in FIG. 1, the information processing apparatus 1 includes a configuration information acquisition unit 2, a user interface unit 3, and a storage control unit 4.

The information processing apparatus 1 is an apparatus used for generating annotation information with respect to an object included in an image. Note that, the object included in an image may be an object included in a part of the image, or may mean an entire image (i.e., the image itself). Hereinafter, each component of the information processing apparatus 1 will be described.

The configuration information acquisition unit 2 acquires object configuration information. Herein, the object configuration information includes a definition of each of one or more elements added to an image in order to indicate an object included in the image, and a definition of order of the element. These definitions are definitions being defined in advance by an administrator or the like, and can be defined optionally.

Herein, the element may be information used for indicating an object, and may be, for example, a figure (a point, a line, a rectangle, a triangle, a perfect circle, an ellipse, an area, or the like), or may be text information. For example, when the object is an eye (iris), as one example, a plurality of points for representing an outline of the eye, a circle representing a pupil, a circle representing the iris, and the like are defined as elements in the object configuration information, and also order of these elements is defined. Needless to say, the example described above is merely one example, and with respect to the object, another element, for example, text information indicating a feature of an eye (for example, the eye of a person belonging to what kind, or the like) may be defined. Further, the object is not limited to an eye. In the object configuration information, an element associated to an object of interest is defined.

The user interface unit 3 provides a user interface in order to accept an input for specifying an element of an object included in an image. Note that, the user interface is used for accepting an input from a user, but it also can be said that the user interface is used for accepting an input from an input apparatus such as a pointing device or a keyboard operated by the user. The image is an image to which annotation information is to be added, and is also referred to as a target image. Herein, the user interface unit 3 provides a user interface being set based on a definition of an element indicated by the object configuration information acquired by the configuration information acquisition unit 2, according to order of the element defined by the object configuration information. For example, the user interface unit 3 provides a user interface being set based on a definition of a first element, and then provides a user interface being set based on a definition of a second element. As described above, the user interface unit 3 sequentially provides a user interface associated to an element. A user performs an input operation for specifically specifying an element with respect to an object included in a target image by using the user interface.

The storage control unit 4 controls in such a way as to store information of the element specified by an input of a user via a user interface provided by the user interface unit 3 in association with the target image.

The information processing apparatus 1 has been described above. According to the information processing apparatus 1, as described above, a user interface associated to each element is automatically provided in order, based on a definition in the object configuration information. For this reason, a user can immediately start an input for specifically specifying an element without performing an operation of selecting a type of the element or the like. Therefore, according to the information processing apparatus 1, it is possible to efficiently add annotation information to an image.

Note that, in the above description, the information processing apparatus 1 including the configuration illustrated in FIG. 1 has been described, but a mode for acquiring the above-described advantageous effect is not limited to an apparatus. For example, a similar advantageous effect can be acquired in an information processing method including the above-described processing of the information processing apparatus 1, a program performing the above-described processing of the information processing apparatus 1, or a non-transitory computer-readable medium in which the program is stored.

### Preparation for Describing Example Embodiment

Herein, an annotation will be discussed as preparation for describing the details of the example embodiment.

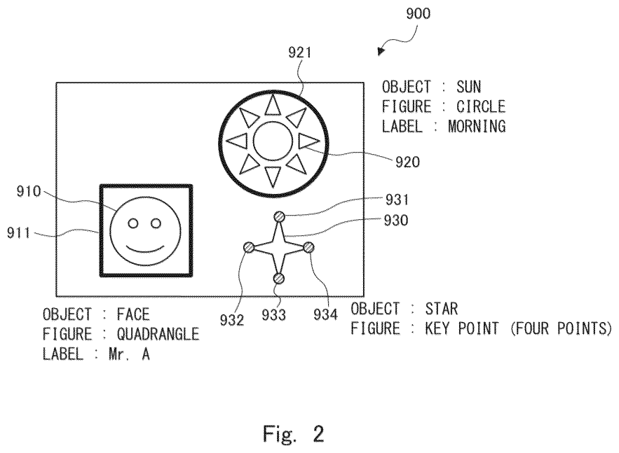

FIG. 2 is a schematic diagram illustrating an example of annotation information with respect to an object in an image, that is, an object included in an image. In an image 900 illustrated in FIG. 2, a human face 910, a sun 920, and a star 930 are present as objects, as one example. For such an image 900, the following annotation information may be considered as an annotation with respect to the object, for example.

For the face 910, for example, a quadrangle 911 (a quadrangular frame line) surrounding the face 910 is added to the image 900 as the annotation information. Furthermore, in order to describe the face 910, a label “Mr. A” is added to the image 900 as the annotation information, as an identifier such as a name indicating who the face 910 is. Further, for the sun 920, for example, a circle 921 (a circular frame line) surrounding the sun 920 is added to the image 900 as the annotation information. Furthermore, for the sun 920, in order to describe the sun 920, a label “morning” is added to the image 900 as the annotation information. Further, for the star 930, for example, points 931, 932, 933, and 934 indicating each vertex of the star 930 are added to the image 900 as the annotation information. As described above, the annotation information with respect to the object included in the image is classified into a figure such as the above-described quadrangle, circle, point, and the like, and a label that describes the object such as “morning”, “Mr. A”, and the like. Note that, the figure and the label that are the annotation information illustrated in FIG. 2 are merely examples, and another figure or another label may be used. For example, a figure may include a point, a line, a rectangle, a triangle, a perfect circle, an ellipse, an area, and the like.

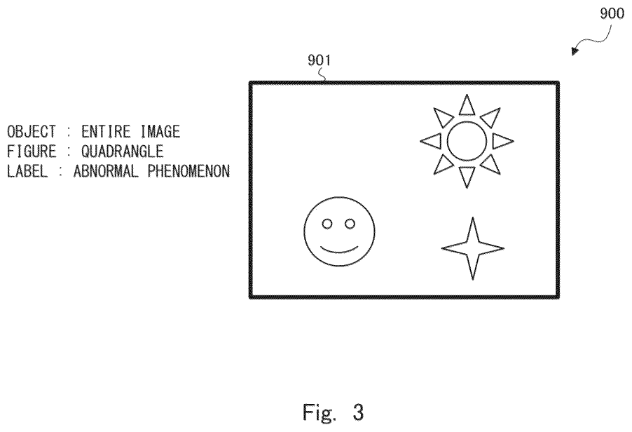

In the example illustrated in FIG. 2, the annotation information with respect to the object included in a part of the image 900 is illustrated, but the entire image 900 can be considered as one object. In other words, the annotation information may be added to the image 900 using the image 900 itself as an object. FIG. 3 is a schematic diagram illustrating an example of the annotation information in a case where the entire image is considered as one object. When the entire image 900 is considered as one object, for example, the following annotation information can be added to the image 900. For the entire image, for example, a quadrangle 901 (a quadrangular frame line) surrounding the entire image is added to the image 900 as the annotation information. Furthermore, in order to describe the entire image, a label “abnormal phenomenon” is added to the image 900 as the annotation information, as information indicating what kind of feature the entire image has. Therefore, the annotation information may be used for an object included in a part of an image, or may be used for an object using the entire image (i.e., the image itself) as the object.

Herein, the annotation information will be further discussed. The annotation information can be classified into an element being essential to be added and an element being optional to be added. For example, the annotation information with respect to the entire image described above may be annotation information added only when a state of the image is abnormal. On the other hand, the other annotation information illustrated in FIGS. 2 and 3 may be defined as annotation information being essential to be added to the image 900.

Hereinafter, example embodiments of the present disclosure will be described in detail with reference to the drawings. Note that, the following description and the drawings are omitted and simplified as appropriate for clarity of description. Further, in each of the drawings, a similar component is denoted by a similar reference sign, and redundant descriptions are omitted as necessary.

### First Example Embodiment

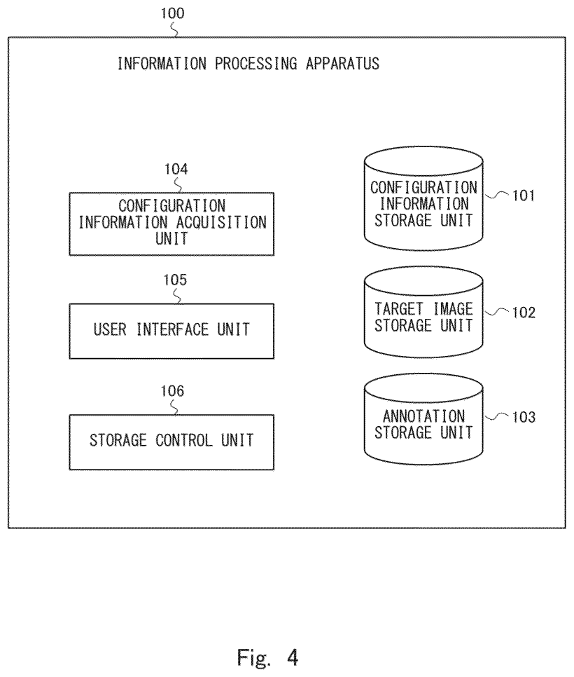

FIG. 4 is a block diagram illustrating one example of a functional configuration of an information processing apparatus 100 according to a first example embodiment. The information processing apparatus 100 is an apparatus used for generating annotation information with respect to an object (an object included in a part of an image, or an object represented by an entire image) included in an image. The information processing apparatus 100 is an apparatus corresponding to the information processing apparatus 1 in FIG. 1. As illustrated in FIG. 4, the information processing apparatus 100 includes a configuration information storage unit 101, a target image storage unit 102, an annotation storage unit 103, a configuration information acquisition unit 104, a user interface unit 105, and a storage control unit 106.

The configuration information storage unit 101 stores various types of configuration information such as object configuration information and task configuration information, which will be described later. In the present example embodiment, the configuration information storage unit 101 stores, in advance, configuration information generated in advance. For example, the configuration information may be information generated by another apparatus or the like, or may be a data file in a predetermined file format. Note that, in the configuration illustrated in FIG. 4, the configuration information storage unit 101 is included in the information processing apparatus 100, but the configuration information storage unit 101 may be achieved by another apparatus communicably connected to the information processing apparatus 100 via a network or the like. Further, the configuration information storage unit 101 may be configured as a database.

The target image storage unit 102 stores a target image being an image to which annotation information is to be added. In the present example embodiment, the target image storage unit 102 specifically stores image data of the target image and an identifier (such as an image ID) for identifying the target image. Note that, in the configuration illustrated in FIG. 4, the target image storage unit 102 is included in the information processing apparatus 100, but the target image storage unit 102 may be achieved by another apparatus communicably connected to the information processing apparatus 100 via a network or the like. Further, the target image storage unit 102 may be configured as a database.

The annotation storage unit 103 stores annotation information specified by a user. In the present example embodiment, the annotation storage unit 103 specifically stores an identifier of the target image and the annotation information in association with each other. Note that, in the configuration illustrated in FIG. 4, the annotation storage unit 103 is included in the information processing apparatus 100, but the annotation storage unit 103 may be achieved by another apparatus communicably connected to the information processing apparatus 100 via a network or the like. Further, the annotation storage unit 103 may be configured as a database.

Herein, configuration information used by the information processing apparatus 100 for processing will be described. In the present example embodiment, the information processing apparatus 100 uses object configuration information and task configuration information as the configuration information.

First, object configuration information will be described. The object configuration information is configuration information related to an object for which annotation information is to be generated, and is configuration information defined for each object. For example, the object may be various objects to be detected from an image, such as an eye (iris), a face, a person, a cat, a dog, an animal, and the like. Further, the object may be an entire image.

In the present example embodiment, the object configuration information specifically includes, as one example, the following data.
Objectname data
Figures data
Labels data
ElementOrder data
GuideSample data
MultiInstance data
Instancenumber data

Herein, the Objectname data are data indicating an object name. Further, the Figures data and the Labels data are data representing a definition of an element (i.e., an element arranged in an image) added to an image as the annotation information in order to indicate an object. As described above, the annotation information with respect to an object included in an image is classified into a figure for determining a position of the object in the image, and a label for describing the object. For this reason, in the present example embodiment, the object configuration information may include the Figures data for defining an element (hereinafter, also referred to as a graphic element) classified into a figure, and the Labels data for defining an element (hereinafter, also referred to as a label element) classified into a label.

The Figures data define a set of figures used as annotation information of an object (more specifically, an object indicated by the Objectname data). When an object is determined by a plurality of figures, the Figures data define a set including a plurality of graphic elements. Note that, when a graphic element is unnecessary, the Figures data become an empty set. Further, the Labels data define a set of labels used as annotation information of an object (more specifically, an object indicated by the Objectname data). When an object is described by a plurality of labels, the Labels data define a set including a plurality of label elements. For example, when an object is an eye, the Labels data may define a set with two label elements as follows. For example, a first label element may be a label that describes whether to be a child's eye or an adult's eye, and a second label element may be a label that describes whether to be a male's eye or a female's eye. Note that, when a label element is unnecessary, the Labels data become an empty set.

Further, each of elements included in the Figures data and the Labels data includes flag information indicating whether to be an element being essential to be added to the target image. In other words, each element includes a parameter indicating whether to be an essential element or an optional element as the annotation information. In this way, the object configuration information includes a definition indicating whether an element is essential to be added to an image.

The ElementOrder data in the object configuration information are data that define order of an element used as annotation information of an object (more specifically, an object indicated by the Objectname data). In particular, the ElementOrder data defines the order for an essential element as annotation information. The ElementOrder data are data that define order in which a specification operation of an element is to be performed when a user specifies the element for an object in order to add annotation information to a target image. Note that, the ElementOrder data may define, for example, order of the graphic elements, but also order of the label elements may be defined not limited to the order of the graphic elements.

The GuideSample data are guide information for describing to a user how an element is to be specified when the user performs a specification operation of the element via a user interface provided by the user interface unit 105 to be described later. The GuideSample data may be text data describing a method of the specification operation, voice data describing a method of the specification operation, or an image describing a method of the specification operation. Herein, the image describing the method of the specification operation is, for example, an image in which an object as a sample and an element arranged at an exemplary position with respect to the object are drawn. Note that, the image describing the method of the specification operation may be a still image, or may be a moving image. Further, the GuideSample data may be data acquired by combining two or more types of data among text data, voice data, and image data. Further, the GuideSample data may be data in a format other than text data, voice data, and image data.

The MultiInstance data are data that define whether the number of objects (specifically, objects defined by the Objectname data) included in one target image is unknown. In the present example embodiment, when a value of a piece of the MultiInstance data is set to “True”, this means that the information processing apparatus 100 processes the target image whose number of objects is unknown. In contrast, when the value of the piece of MultiInstance data is set to “False”, this means that the information processing apparatus 100 processes the target image whose number of the objects is a fixed number. Therefore, for example, in a case of assuming that the information processing apparatus 100 processes only a target image including a predetermined number of predetermined objects, “False” is set as the value of the piece of MultiInstance data.

The Instancenumber data are data representing the fixed number described above. In other words, the Instancenumber data are data representing how many objects determined by the Objectname data exist in one target image. For this reason, in the present example embodiment, the Instancenumber data are set to an integer of one or more when the value of the piece of MultiInstance data is “False”. In contrast, the Instancenumber data are set to “Null” when the value of the piece of MultiInstance data is “True”.

The object configuration information is not limited to the data described above, and may include other data. For example, the object configuration information may include constraint condition data that define a constraint condition of arrangement of an element on a target image. By including the object configuration information in the constraint condition data, it is possible to promote arrangement of each element in such a way as to satisfy a predetermined rule for the arrangement, as described later. The constraint condition data may be a constraint focusing on one element, or may be a constraint focusing on a plurality of elements. In other words, the constraint condition data may be data that restrict a relative relationship of a plurality of elements on a target image. More specifically, the constraint condition data may be data that restrict a geometric relationship. The geometric relationship may be, for example, a positional relationship between a plurality of elements, an inclusion relationship between a plurality of elements, or a magnitude relationship between a plurality of elements. By using the constraint condition data that restrict the relative relationship of the plurality of elements on the target image, it is possible to suppress occurrence of inappropriate arrangement of the element whose relative relationship does not satisfy a predetermined rule. For example, it is possible to suppress that a point representing a center of an eyelid is arranged at a position deviated from a bisector line between a point at an outer corner of the eye and a point at an inner corner of the eye. Further, for example, it is possible to suppress that a circle representing a pupil is arranged in such a way as to include a circle representing an iris.

Next, the task configuration information will be described. The task configuration information is configuration information indicating a set of one or more objects, and defines which object the annotation information is to be added to one image. In other words, the task configuration information is configuration information that defines which object is to be performed a task for adding annotation information to a target image. In the task configuration information, to one image, it may be defined to add annotation information for one type of object, or it may be defined to add annotation information for a plurality of types of objects.

In the present example embodiment, the task configuration information specifically includes, as one example, the following data.
Taskname data
Object data
ObjectOrder data

Herein, the Taskname data are data indicating a task name. Further, the Object data are data that define which object the annotation information is to be added to one image. In other words, the Object data are data that define a set of objects defined by the object configuration information. Specifically, the Object data are represented as a set of the Objectname described above.

The ObjectOrder data in the task configuration data are data that define order of objects indicated by the Object data. In other words, the ObjectOrder data in the task configuration information are data that define the order of performing the specification operations on which object when performing the specification operation on an element for generating annotation information for each object indicated by the Object data. For example, it is assumed that the order of the objects is defined in order of an object A, an object B, and an object C in the ObjectOrder data in the task configuration information. In this case, a user first performs the specification operation of an element with respect to the object A, next performs the specification operation of an element with respect to the object B, and then performs the specification operation of an element with respect to the object C.

As described above, when the ObjectOrder data are set in the task configuration information, a user performs an operation for adding the annotation information for each object according to the set order. At that time, switching of the objects is automatically performed according to the defined order. In other words, when the specification operation for one object is completed, a target of the specification operation is switched to the next object specified in the defined order.

Note that, in the above description, the task configuration information includes a definition of order of a plurality of objects, but the task configuration information may not necessarily include such a definition. In other words, the task configuration information does not need to include the ObjectOrder data. In this case, a user needs to instruct to perform an operation for adding annotation information on which object, via a user interface provided by the user interface unit 105 to be described later. In other words, when the order of the objects is not defined in the task configuration information, a user needs to input an instruction to select the object.

In the present example embodiment, the configuration information storage unit 101 of the information processing apparatus 100 stores the above-described object configuration information and task configuration information in advance. Note that, the configuration information storage unit 101 may store a plurality of pieces of task configuration information. For example, various pieces of task configuration information may be stored, such as task configuration information for generating annotation information with respect to an animal included in a target image, task configuration information for generating annotation information with respect to a human eye included in the target image, and the like. As described above, by storing various pieces of task configuration information and object configuration information in the configuration information storage unit 101, the information processing apparatus 100 can be used for adding various pieces of annotation information.

The configuration information acquisition unit 104 corresponds to the configuration information acquisition unit 2 in FIG. 1. In the present example embodiment, the configuration information acquisition unit 104 acquires the object configuration information and the task configuration information stored in the configuration information acquisition unit 104. The configuration information acquisition unit 104 acquires the task configuration information selected in response to an instruction from a user, and also acquires the object configuration information of an object being set in the task configuration information. For example, a user who desires to generate annotation information with respect to an eye included in a target image inputs an instruction, to the information processing apparatus 100, to select the task configuration information for generating annotation information with respect to the eye. As a result, the configuration information acquisition unit 104 acquires such task configuration information from the configuration information storage unit 101, and also acquires the object configuration information of the object indicated in the Object data in the task configuration information from the configuration information storage unit 101. Note that, an instruction from a user does not necessarily to be an instruction to select the task configuration information, and may be an instruction to determine what kind of annotation information is desired to be generated. In this case, the configuration information acquisition unit 104 may acquire, from the configuration information storage unit 101, the task configuration information associated to the type of annotation information instructed by a user. As described above, the configuration information acquisition unit 104 acquires the configuration information associated to an instruction from a user among the various pieces of configuration information for generating the annotation information.

The user interface unit 105 corresponds to the user interface unit 3 in FIG. 1. The user interface unit 105 reads a target image stored in the target image storage unit 102. Further, the user interface unit 105 outputs, based on the configuration information acquired by the configuration information acquisition unit 104, a user interface that accepts an input, from a user, for generating annotation information for the read target image. Specifically, for example, the user interface unit 105 displays a user interface screen on an output apparatus 150 described later. In other words, the user interface unit 105 provides a graphical user interface (GUI).

The user interface unit 105 provides a user interface in which only a user interface (UI) component necessary for generating annotation information with respect to an object indicated in the task configuration information acquired by the configuration information acquisition unit 104 is arranged. In other words, the user interface unit 105 provides a user interface in which a UI component necessary for generating annotation information with respect to another object not indicated in the task configuration information acquired by the configuration information acquisition unit 104 is not arranged. Therefore, the user interface provided by the user interface unit 105 is different depending on the configuration information acquired by the configuration information acquisition unit 104. In other words, the user interface provided by the user interface unit 105 is different depending on a purpose of a user. For example, when a user desires to generate annotation information with respect to an animal, that is, when the object is an animal, the user interface unit 105 provides a user interface specialized for generating annotation information with respect to the animal. In contrast, for example, when a user desires to generate annotation information with respect to a human eye, that is, when the object is an eye, the user interface unit 105 provides a user interface specialized for generating annotation information with respect to the eye. More specifically, for example, when the object is an animal, the user interface unit 105 provides the following user interface. In this case, a user interface that includes a UI component for accepting an input for an element defined in the object configuration information with respect to the animal and does not include a UI component for accepting an input for another element is provided. For example, it is assumed that only a quadrangle is defined in the Figures data of the object configuration information with respect to the animal. In this case, a user interface that includes a UI component for specifying a quadrangle on a target image and does not include a UI component for specifying Similarly, for example, when the object a point, a circle, or the like is provided. is an eye, the user interface unit 105 provides the following user interface. In this case, a user interface that includes a UI component for accepting an input for an element defined in the object configuration information with respect to the eye and does not include a UI component for accepting an input for another element is provided. For example, it is assumed that only a point and a circle are defined in the Figures data of the object configuration information with respect to the eye. In this case, a user interface that includes a UI component for specifying a point and a UI component for specifying a circle, and does not include a UI component for specifying a quadrangle or the like is provided.

When a plurality of types of objects are indicated in the acquired task configuration information, the user interface unit 105 provides a user interface specialized for any of the objects. In other words, in this case, the user interface unit 105 refers to the object configuration information of any object, and provides a user interface in which only a UI component necessary for generating annotation information with respect to the object is arranged. When the task configuration information includes a definition (ObjectOrder data) of order of a plurality of objects, the user interface unit 105 provides a user interface by referring to the object configuration information selected according to the order of the plurality of objects defined in the task configuration information. According to such a configuration, it is possible to sequentially provide a user interface specialized for each object, regardless of a switching instruction by a user. For this reason, more efficient work can be achieved. In contrast, when the task configuration information does not include the definition of the order of the plurality of objects, the user interface unit 105 may provide a user interface by referring to the object configuration information selected according to an instruction from a user. In other words, a user may specify performing an input for which object. According to such a configuration, since a user can freely switch the object, convenience is improved.

Further, the user interface unit 105 provides a user interface according to the order of elements defined in the object configuration information acquired by the configuration information acquisition unit 104. Specifically, the user interface unit 105 provides a user interface according to the defined order of the elements in the following manner. The user interface unit 105 provides a user interface for accepting specification for an element whose defined order is an n-th, and then when accepting specification from a user, provides a user interface for accepting specification for an element whose defined order is an n+1-th. However, n represents an integer of one or more. More specifically, the user interface unit 105 accepts specification from a user after providing the user interface for accepting specification for an element whose defined order is the n-th, and then accepts the specification as specification for the n-th element. For this reason, a user does not need to perform an input indicating the specification for an element of what number.

The user interface unit 105 determines the type of the element whose order is the n-th, and provides a user interface specialized for accepting an input specifying the element of the determined type as a user interface for accepting the specification for the element whose order is the n-th. In other words, the user interface unit 105 determines the type of the element whose order is the n-th, and provides a user interface of an input mode associated to the determined type as a user interface for accepting the specification for the element whose order is the n-th. For example, it is assumed that the type of the element whose order is the n-th is a point, and the type of the element whose order is the n+1-th is a circle. In this case, the user interface unit 105 provides a user interface specialized for accepting the specification of a position of the point arranged in the target image, and then when accepting specification from a user, provides a user interface specialized for accepting the specification of a position of the circle. In other words, the user interface unit 105 provides a user interface of a point input mode, and then provides a user interface of a circle input mode without receiving a mode change instruction from a user. As described above, the user interface unit 105 automatically switches a user interface triggered by accepting an instruction to specify an element.

Note that, as described above, the object configuration information may also define an element being optional to be added to the target image as the annotation information. In the present example embodiment, order of such element is not set by the ElementOrder data. For this reason, when the object configuration information defines such an element, the user interface unit 105 provides a user interface as follows in order to enable to accept, from a user, an input for specifying the element. In other words, in this case, the user interface unit 105 provides a user interface including a UI component for switching to an input mode for inputting the specification for the element. As a result, a user can input the specification for an element being optional to be added as necessary.

The user interface unit 105 has been described above. As can be seen from the above description, the user interface unit 105 provides a user interface by referring to the object configuration information of any object included in a set indicated by the task configuration information acquired by the configuration information acquisition unit 104. As a result, even when annotation information is generated for each of various objects included in the same target image, it is possible to provide a user interface capable of efficiently generating annotation information with respect to the object for each object.

The storage control unit 106 corresponds to the storage control unit 4 in FIG. 1. The storage control unit 106 controls in such a way as to store, as annotation information, information of an element specified by an input of a user via a user interface provided by the user interface unit 105 in association with a target image. Specific graphic information can be acquired for each element by the input of a user via the user interface. Then, when there is specification for a label element, label information with respect to an object determined by the specified element is also acquired. The storage control unit 106 controls in such a way as to store the acquired information, as the annotation information, in the annotation storage unit 103 in association with the target image. In the present example embodiment, the storage control unit 106 stores a pair of an image ID of the target image and the annotation information with respect to the target image in the annotation storage unit 103. Note that, the graphic information is information determining arrangement of a figure in the target image, and may include coordinate information representing a position in the target image, or may be information defining a geometric feature such as a radius size. Further, the label information is information indicating a content of a label.

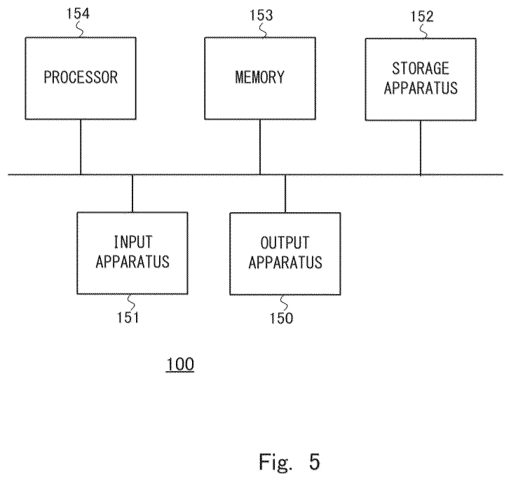

FIG. 5 is a block diagram illustrating one example of a hardware configuration of the information processing apparatus 100. As illustrated in FIG. 5, the information processing apparatus 100 includes the output apparatus 150, an input apparatus 151, a storage apparatus 152, a memory 153, and a processor 154.

The output apparatus 150 is an output apparatus such as a display that outputs information to an outside. The display may be, for example, a flat panel display such as a liquid crystal display, a plasma display, or an organic electro-luminescence (EL) display. The output apparatus 150 is not limited to the display, and may be another apparatus. For example, the output apparatus 150 may be a projection apparatus such as a projector. Further, the output apparatus 150 may include a speaker. The output apparatus 150 displays a user interface provided by the user interface unit 105.

The input apparatus 151 is an apparatus for performing an input by a user via a user interface, and is, for example, an input apparatus such as a pointing device or a keyboard. Examples of the pointing device include a mouse, a trackball, a touch panel, a pen tablet, and the like. The input apparatus 151 and the output apparatus 150 may be integrally formed as a touch panel.

The storage apparatus 152 is a non-volatile storage apparatus such as a hard disk or a flash memory. The configuration information acquisition unit 104, the target image storage unit 102, and the annotation storage unit 103 described above are achieved by, for example, the storage apparatus 152, but may be achieved by another storage apparatus.

The memory 153 is configured by, for example, a combination of a volatile memory and a non-volatile memory. The memory 153 is used for storing software (a computer program) including one or more instructions to be executed by the processor 154, data used for various pieces of processing of the information processing apparatus 100, and the like.

The processor 154 reads and executes the software (computer program) from the memory 153, and thereby performs processing of the configuration information acquisition unit 104, the user interface unit 105, and the storage control unit 106 described above. The processor 154 may be, for example, a microprocessor, a micro processor unit (MPU), a central processing unit (CPU), or the like. The processor 154 may include a plurality of processors.

As described above, the information processing apparatus 100 has a function as a computer.

A program includes instructions (or a software code) that, when loaded into a computer, cause the computer to execute one or more of functions described in the example embodiments. The program may be stored in a non-transitory computer-readable medium or a tangible storage medium. By way of example, and not limitation, the computer-readable medium or the tangible storage medium includes a random-access memory (RAM), a read-only memory (ROM), a flash memory, a solid-state drive (SSD), or another memory technique, a CD-ROM, a digital versatile disc (DVD), a Blu-ray (registered trademark) disk, or another optical disk storage, a magnetic cassette, a magnetic tape, a magnetic disk storage, or another magnetic storage device. The program may be transmitted on a transitory computer-readable medium or a communication medium. By way of example, and not limitation, the transitory computer-readable medium or the communication medium includes a propagation signal in electrical, optical, acoustic, or another form.

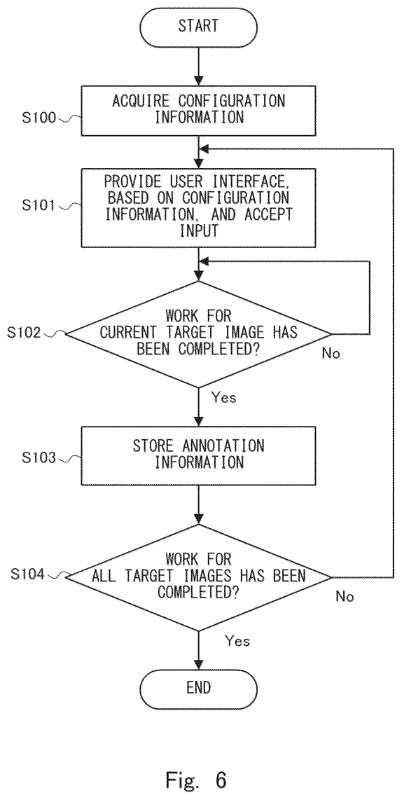

Next, operation of the information processing apparatus 100 will be described with reference to a flowchart. FIG. 6 is a flowchart illustrating one example of operation of the information processing apparatus 100. Hereinafter, a flow of operation of the information processing apparatus 100 will be described with reference to FIG. 6.

In step S100, the configuration information acquisition unit 104 acquires object configuration information and task configuration information stored in the configuration information acquisition unit 104. As described above, the configuration information acquisition unit 104 acquires configuration information associated to a purpose of an annotation desired by a user. In other words, the configuration information acquisition unit 104 acquires configuration information associated to a type of annotation information that a user desires to generate.

Next, in step S101, the user interface unit 105 provides a user interface, based on the configuration information acquired in step S100, and accepts an input from a user. Specifically, the user interface unit 105 reads a target image stored in the target image storage unit 102. Then, the user interface unit 105 outputs, to the output apparatus 150, a user interface that accepts, from a user, an input for generating annotation information for the read target image, based on the configuration information acquired by the configuration information acquisition unit 104. At that time, the user interface unit 105 provides a user interface different for each definition of an object (i.e., for each definition of an element added to an image in order to indicate the object). Then, the user interface unit 105 accepts an input via the input apparatus 151. When it is defined, in the task configuration information, that annotation information is added to a plurality of types of objects, the user interface unit 105 accepts a specification operation of an element for each object.

Next, in step S102, the user interface unit 105 decides whether generation work, by a user, of the annotation information for the target image currently handled by the user interface unit 105 has been completed. For example, in a case where the element defined in the object configuration information is only an element being essential to be added, the user interface unit 105 decides that the generation work has been completed when an instruction for all the elements defined in the object configuration information is input from a user. Further, when the element defined in the object configuration information includes an element being optional to be added, the user interface unit 105 decides that the generation work has been completed when an input of an instruction indicating that the generation work has been completed is accepted from a user. Note that, when a plurality of objects are specified in the task configuration information, the user interface unit 105 decides that the generation work for the currently handled target image has been completed when the operation for all the objects has been completed. The present step is repeated until the generation work is completed, and when the generation work is completed, processing proceeds to step S103.

In step S103, the storage control unit 106 controls in such a way as to store, as the annotation information, information of the element specified by the input of a user via the user interface provided by the user interface unit 105 in association with the target image. As a result, addition of the annotation information to one target image is achieved.

Next, in step S104, the user interface unit 105 decides whether the generation work of the annotation information for all the target images included in a predetermined image group has been completed. When the target image for which the generation work of the annotation information has not been completed remains, the processing returns to step S101, and the processing described above is repeated. On the other hand, when the generation work of the annotation information for all the target images included in the predetermined image group is completed, the processing is ended.

Next, a specific example of the configuration information and a specific example of a user interface provided by the user interface unit 105 will be described.

The configuration information exemplified below is configuration information in a case of generating annotation information with respect to an eye (iris) included in the target image.

The object configuration information in this case includes, for example, the following data.
Objectname data: eye
Figures data: {“F1”: Point, . . . , “F8”: Point, “I9”: Circle, “I10”: Circle}
Labels data: {}
ElementOrder data: {“F1”, “F2”, “F3”, “F4”, “F5”, “F6”, “F7”, “F8”, “I9”, “I10”}
GuideSample data: {EyeGuideSampledata}
MultiInstance data: False
Instancenumber data: 1
Constraint condition data: “F3”: Point->constmode=BISECTOR, p1=“F1”, p2=“F2” . . . and the like

The above-described object configuration information defines an eye as an object. According to the Objectname data, the object name is “eye”.

Further, according to the Figures data, it is defined that eight points and two circles are used as a figure for determining the eye in the target image. In other words, it is defined, according to the Figures data, that the elements added to the target image in order to indicate the eye included in the target image are eight points and two circles. Note that, in the Figures data, F1, F2, . . . , F8, I9, and I10 are identifiers of the elements. Further, “Point” and “Circle” described after the identifier indicate the type of the figure. Note that, the ten elements are defined as elements that are essential to be added to the target image.

In the above-described object configuration information, the Labels data are an empty set. For this reason, in the above-described example, a label is not generated as the annotation information. However, the Labels data may be defined. For example, a label for describing the eye may be defined, such as whether to be a child's eye or an adult's eye.

Further, according to the ElementOrder data, order of the ten elements described above is set. For this reason, the specification operation for each of the ten elements is performed according to the order indicated in the ElementOrder data.

Further, according to the GuideSample data, it is defined that EyeGuideSampledata is referred to as guide information for generation work of the annotation information of the eye.

Further, since a value of a piece of the MultiInstance data is “False”, it is defined that annotation information is added to the target image in which the number of eyes included in one image is a predetermined number. The predetermined number is 1 because a value of a piece of the Instancenumber data is 1. In other words, the object configuration information is used in a case where generation of annotation information is performed using an image having a number of eyes of 1 as the target image.

Further, the above-described object configuration information includes the constraint condition data, and it is defined that a position of a point represented by the identifier F3 needs to be present on the bisector line between a point represented by the identifier F1 (the point at an inner corner of the eye) and a point represented by the identifier F2 (the point at an outer corner of the eye), and the like.

Further, the task configuration information includes, for example, the following data.
Taskname data: eyeAnnotationTask
Object data: eye
ObjectOrder data: {eye}

The above-described task configuration information defines a task generating annotation information with respect to the eye. According to the Taskname data, a task name is eyeAnnotationTask. Then, according to the Object data, it is defined that annotation information is to be added to one target image by referring to the object configuration information whose Objectname data are eye. Herein, although an example in which annotation information is added to one object is indicated, as described above, it is also possible for the task configuration information to specify a plurality of objects, and in that case, it is also possible to define order thereof. Further, the order of the objects is specified in the ObjectOrder data, but herein, since there is only one object, the ObjectOrder data include only “eye”.

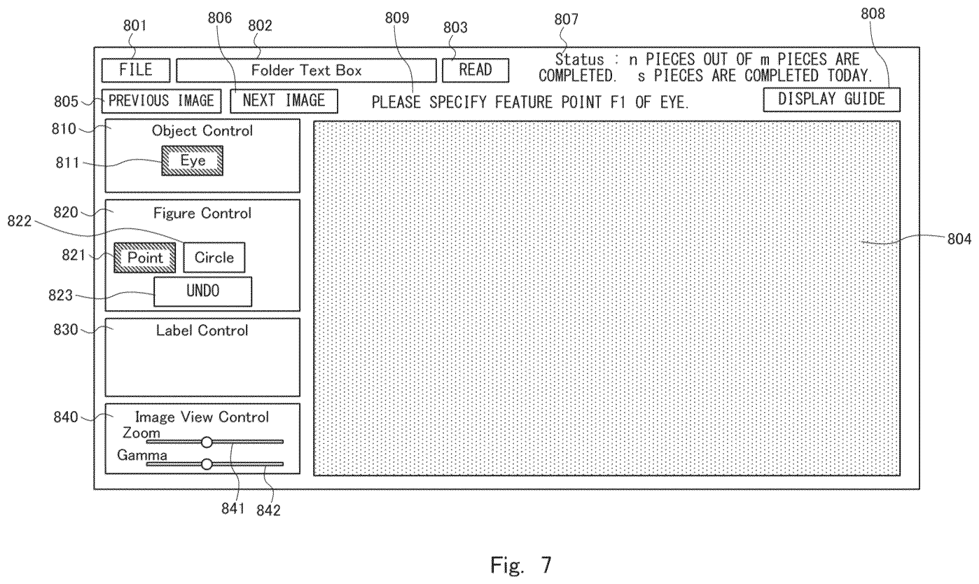

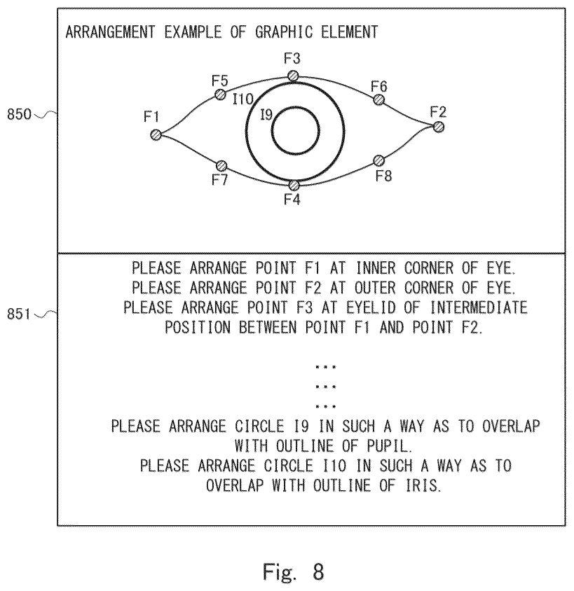

Next, a specific example of a user interface provided by the user interface unit 105 will be described. FIGS. 7 and 9 to 12 are schematic diagrams illustrating an example of a screen of a user interface displayed on the output apparatus 150 by the user interface unit 105. Further, FIG. 8 is a schematic diagram illustrating an example of guide information displayed on the output apparatus 150 by the user interface unit 105. FIGS. 7 to 12 illustrate examples in a case where the configuration information acquisition unit 104 acquires, in response to an instruction from a user, the task configuration information in which the Taskname data are eyeAnnotationTask and the object configuration information in which the Objectname data are eye.

The user interface unit 105, first, provides a user interface as illustrated in FIG. 7. Each UI component of the user interface illustrated in FIG. 7 will be described. A file button 801 is a button providing a menu for specifying the target image. For example, by the file button 801, a menu for specifying a folder in which the target image to which the annotation information with respect to the eye is to be added is stored is provided. A folder text box 802 is an area displaying a file path of a folder in which an image is stored. A read button 803 is a button for reading an image in the folder determined by the file path displayed in the folder text box 802 as a target image.

An image window 804 is an area displaying the read target image. A user performs an operation of specifying an element defined in the object configuration information with respect to the target image displayed in the image window 804. In the example herein, the target image including one eye is displayed in the image window 804.

An image change button 805 and an image change button 806 are buttons for a user to forcibly switch the target image to which the annotation information is added. By pressing the image change button 805, the target image is switched to a previous image. Similarly, by pressing the image change button 806, the target image is switched to a next image. Note that, when generation operation of the annotation information for one target image is completed, the user interface unit 105 automatically switches the target image to the next image. In particular, when the value of the piece of MultiInstance data is “False”, switching of the target image is performed as follows. In this case, the user interface unit 105 automatically switches the target image to the next image when the specification operation for the element is completed for each of the numbers of the objects indicated by the Instancenumber data. In the example herein, the user interface unit 105 automatically switches the target image to the next image when the specification operation of eight points and two circles is completed with respect to one target image. Note that, when the task configuration information defines addition of the annotation information for a plurality of types of objects, the user interface unit 105 switches the target image to the next image at a time point when the specification operation of the elements for all the objects is completed.

A status area 807 is an area displaying progress status of the generation work of the annotation information. In this area, the user interface unit 105 indicates, for example, how many images out of all the images in the folder determined by the file path displayed in the folder text box 802 have been subjected to completion of the generation work of annotation information. Further, the user interface unit 105 may display the total number of images for which the generation work of the annotation information has been completed.

A guide display button 808 is a button for outputting guide information. When a user operates this button, the guide information defined in the GuideSample data in the object configuration information is outputted. In the example herein, information indicated by the EyeGuideSampledata is outputted as the guide information for the generation work of the annotation information of the eye. FIG. 8 is a diagram illustrating one example of information indicated by the EyeGuideSampledata. In the example illustrated in FIG. 8, an image 850 indicating an arrangement example of each graphic element defined in the object configuration information and a text 851 describing an arrangement method of each element are displayed as the guide information. Note that, as described above, the guide information may be voice or the like.

As described above, the user interface unit 105 may output guide information guiding an input for specifying an element of an object included in an image. According to such a configuration, since a user can perform an input while referring to the guide information, convenience of the user is improved.

A work notification area 809 is an area notifying a user of work to be performed at present. The user interface unit 105 refers to the object configuration information, and decides a content to be notified. In the example herein, according to the ElementOrder data of the object configuration information, first, it is defined that the specification operation for the point of the identifier F1 is to be performed. For this reason, as illustrated in FIG. 7, the user interface unit 105 displays a notification that “Please specify a feature point F1 of the eye.” as a first notification in the work notification area 809. As described above, the user interface unit 105 switches the notification of a work content to be performed by a user according to the definition of the element indicated by the object configuration information.

An object control area 810 is an area displaying a UI component for selecting an object to be performed the generation work of the annotation information. The user interface unit 105 displays only the UI component of the object defined in the acquired task configuration information. In the example illustrated herein, only eye is defined as an object in the task configuration information. Therefore, as illustrated in FIG. 7, the user interface unit 105 displays only an object button 811 for the eye in the object control area 810. In other words, a button for an object not being defined in the acquired task configuration information, such as an object button for a dog or an object button for a cat, is not displayed. For this reason, a UI screen in which an unnecessary UI component is not displayed and complication is suppressed is provided. Then, as illustrated in FIG. 7, the user interface unit 105 provides a user interface in a state where the object button 811 for the eye is selected in advance.

Note that, when a plurality of objects are specified in the task configuration data, each of the buttons of the plurality of objects is arranged in the object control area 810. In this case, a user can switch the object to which the annotation information is added by selecting any of the buttons. However, when the ObjectOrder data are defined in the acquired task configuration data, the user interface unit 105 automatically switches the object according to the defined order regardless of an operation by a user for the object control area 810. In other words, when the specification operation for one object is completed, the user interface unit 105 switches to the next object specified in the defined order.

A figure control area 820 is an area displaying a UI component for selecting a graphic element to be performed the specification operation. The user interface unit 105 displays only the UI component for the graphic element defined in the acquired object configuration information. As described above, the user interface unit 105 switches a type of an instruction that may be accepted according to the definition of the element indicated by the object configuration information. In the example illustrated herein, only a point and a circle are defined as graphic elements in the object configuration information. Therefore, as illustrated in FIG. 7, the user interface unit 105 displays only a graphic element button 821 for a point and a graphic element button 822 for a circle in the figure control area 820. In other words, a button for a graphic element not being defined in the acquired object configuration information, such as a graphic element button for a quadrangle or a graphic element button for a line, is not displayed. In other words, the user interface unit 105 provides a user interface capable of being only any of the point input mode and the circle input mode. For this reason, a UI screen in which an unnecessary UI component is not displayed and complication is suppressed is provided.

A user can switch which graphic element is to be performed the specification operation by selecting a button displayed in the figure control area 820. However, with respect to the graphic element defined by the ElementOrder data in the acquired object configuration information, the user interface unit 105 can automatically switch the graphic element according to the order defined by the ElementOrder data. In other words, the user interface unit 105 switches the input mode according to the ElementOrder data in the object configuration information. As described above, in the present example embodiment, the ElementOrder data define the order of the element being essential to be added.

As described above, an input target element is automatically switched according to the order defined by the ElementOrder data, and thereby, an operation by a user for specifying the input target can be reduced. For this reason, it is possible to improve efficiency in the specification operation of the element.

In the example herein, according to the ElementOrder data of the object configuration information, first, it is defined that the specification operation for the point of the identifier F1 is to be performed. For this reason, the user interface unit 105, first, provides a user interface specialized for accepting an input specifying a point. For this reason, as illustrated in FIG. 7, the user interface unit 105, first, provides a user interface of the point input mode.

Note that, in the example illustrated herein, the object configuration information defines only a graphic element being essential to be added, but the object configuration information may include a definition of a graphic element being optional to be added. In this case, a user interface for such a graphic element may be provided in response to an instruction from a user to switch the user interface. In other words, switching of the input mode may be performed in response to an instruction from a user.

As described above, the user interface unit 105 sequentially provides a user interface being set based on a definition of an element being essential to be added, according to order defined in the object configuration information. In contrast, the user interface unit 105 provides a user interface associated to a definition of an element not being essential to be added, in response to an instruction from a user to switch the user interface. According to such processing of the user interface unit 105, even in a case where an element not being essential to be added may be added to the target image, it is possible to accept the specification operation for an optional element as necessary while improving efficiency in the specification operation for an essential element.

Further, the figure control area 820 includes a cancel button 823 for canceling the operation. By operating this button, a user can cancel the specification operation being input immediately before.

A label control area 830 is an area displaying a UI component for performing the specification operation on a label element. The user interface unit 105 displays only the UI component for the label element defined in the acquired object configuration information. In the example illustrated herein, no label element is defined in the object configuration information. For this reason, in the label control area 830, display for the label element is omitted. Therefore, a UI screen in which an unnecessary UI component is not displayed and complication is suppressed is provided.

When a label element is defined in the object configuration information, in the label control area 830, the UI component for deciding a value of each of the label elements is arranged. Such a UI component may be a UI component for specifying a value, and may be a radio button, a check box, or a text box.

Note that, when the ElementOrder data of the object configuration information defines order of the label elements, the user interface unit 105 may sequentially provide a user interfaces for accepting the values of each of the label elements according to the defined order. Note that, the user interface for accepting the value of the label element can be set based on a definition of the label element indicated by the object configuration information. For example, the user interface unit 105 may repeatedly, by the number of label elements in which the order is defined, provide a user interface that accepts an n-th input for specifying the value of the label element as an input for specifying the value of the n-th label element in the defined order. Herein, n is an integer of one or more. Alternatively, the user interface unit 105 may provide a user interface including a UI component for accepting the value of the n-th label element, and then provide a user interface including a UI component for accepting the value of an n+1-th label element. In other words, the user interface unit 105 may sequentially provide the UI components associated to the label elements in which the order is defined. Note that, the object configuration information may include a definition of a label element being optional to be added. In this case, a user interface for such a label element may be provided in response to an instruction from a user to switch the user interface. In other words, switching of the user interface for specifying the label element may be performed in response to an instruction from a user.

As described above, for a label element as well, the user interface unit 105 may sequentially provide a user interface being set based on a definition of an element being essential to be added, according to order defined in the object configuration information. Then, for the label element as well, the user interface unit 105 may also provide a user interface associated to a definition of an element not being essential to be added, in response to an instruction from a user to switch the user interface. For this reason, even in a case where an element not being essential to be added may be added to the target image, it is possible to accept the specification operation for an optional element as necessary while improving efficiency in the specification operation for an essential element.

An image view control area 840 is an area in which a UI component for adjusting display of the target image displayed in the image window 804 is arranged. In the example illustrated in FIG. 7, a zoom slider 841 for specifying magnification or reduction of the target image and a gamma slider 842 for adjusting a gamma value are arranged. Note that, in the image view control area 840, a UI component for adjusting other items, such as a UI component for adjusting rotation of an image or a UI component for adjusting brightness of the image, may be arranged. Further, the object configuration information or the task configuration information may define that a UI component adjusting what kind of item is to be arranged. Note that, an adjustment result is preferably maintained even when the displayed target image changes, but may be reset for each target image. However, when the adjustment result of display is maintained even when the target image to be displayed is changed, a user does not need to perform adjustment for each target image, and thus convenience is improved.

Although the screen of the user interface illustrated in FIG. 7 has been described above, the user interface may further include a button or the like not illustrated in FIG. 7. For example, in a case where the value of the piece of MultiInstance data is set to “True”, that is, in a case where the number of objects is unknown, there may be a completion button being operated by a user in a case where work on all the objects included in the target image is completed.

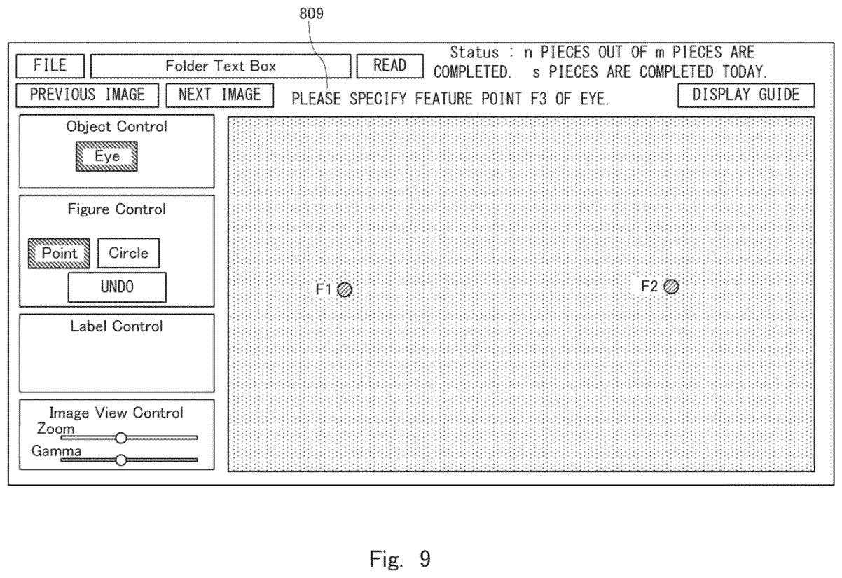

FIG. 9 is a schematic diagram illustrating a user interface immediately after the specification operation for a point of the identifier F1 and the specification operation for a point of the identifier F2 are performed. In the object configuration information, since it is defined that the specification operation of a point of the identifier F3 is performed next to the point of the identifier F2, a notification that “Please specify a feature point F3 of the eye.” is displayed in the work notification area 809.

In the example illustrated herein, as described above, the object configuration information includes the constraint condition data that restrict a position of the feature point F3. The user interface unit 105 may support an input for specifying an element by a user, based on a constraint condition, when the constraint condition for arrangement of an element on an image is set. According to such a configuration, it is possible to promote arrangement of each element in such a way as to satisfy a predetermined rule for the arrangement.

For example, when an input accepted from a user does not satisfy the constraint condition, the user interface unit 105 may correct a position of a graphic element specified by the input to a position satisfying the constraint condition. For example, when an input accepted from a user does not satisfy the constraint condition, the user interface unit 105 may automatically move a position of a graphic element specified by the input to a position in a vicinity of the position specified by the input and satisfying the constraint condition. In the example herein, in the constraint condition data, it is required that a position of the point represented by the identifier F3 is present on the bisector line between the point represented by the identifier F1 and the point represented by the identifier F2. For this reason, for example, when the position of the point of the identifier F3 specified by a user is not on the bisector line between the point represented by the identifier F1 and the point represented by the identifier F2, the user interface unit 105 may automatically move the position of the point of the identifier F3 to the following position. In other words, the user interface unit 105 may move the position of the point of the identifier F3 to a position in the vicinity of the position specified by a user and on the bisector line. The position in the vicinity of the position specified by a user and on the bisector line may be a position of an intersection of a perpendicular line from the position specified by the user to the bisector line, and the bisector line. As described above, the user interface unit 105 corrects a position of a graphic element specified by an input to a position satisfying the constraint condition, and thereby the graphic element can be easily arranged at the position satisfying the constraint condition.

Further, the support of an input for specifying an element by a user may be as follows. For example, the user interface unit 105 may output a warning when an input accepted from a user does not satisfy the constraint condition. For example, when the input accepted from a user does not satisfy the constraint condition, the user interface unit 105 outputs a warning notifying that the input position is a position that does not satisfy the constraint condition. Further, the warning may also include a notification guiding the position that satisfies the constraint condition. Note that, the output of the warning may be an output by display, or may be an output by voice. As described above, the user interface unit 105 outputs a warning when a position of a graphic element specified by an input does not satisfy the constraint condition for arrangement of the graphic element on an image, and thereby it is possible to suppress arrangement of the graphic element at an inappropriate position.

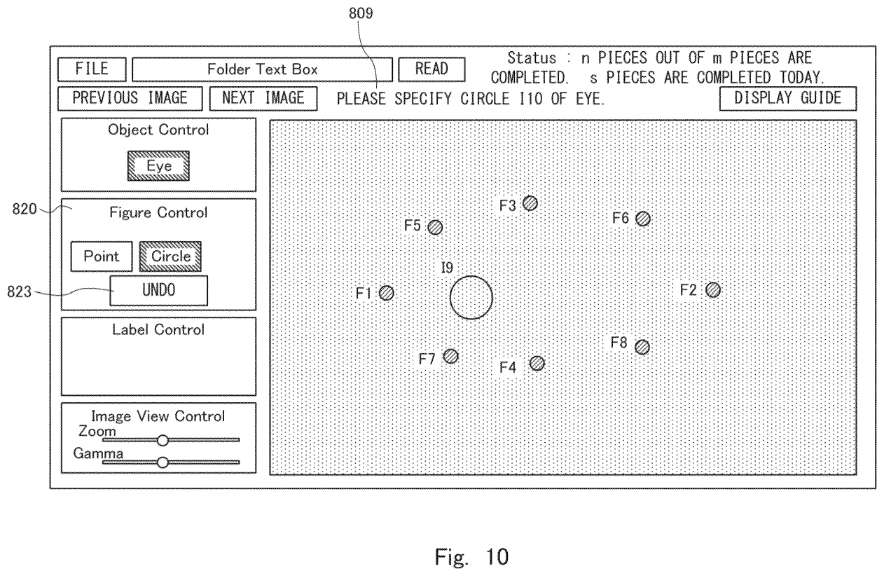

FIG. 10 is a schematic diagram illustrating a user interface immediately after the specification operation for points of the identifiers F1 to F8 and the specification operation for a circle of an identifier I9 are performed. In the object configuration information, since it is defined that the specification operation of a circle of an identifier I10 is performed next to the circle of the identifier I9, a notification that “Please specify a circle I10 of the eye.” is displayed in the work notification area 809. Further, since the specification operation to be performed next is the specification of a position of the circle, as illustrated in the figure control area 820 in FIG. 10, the circle input mode is automatically set.

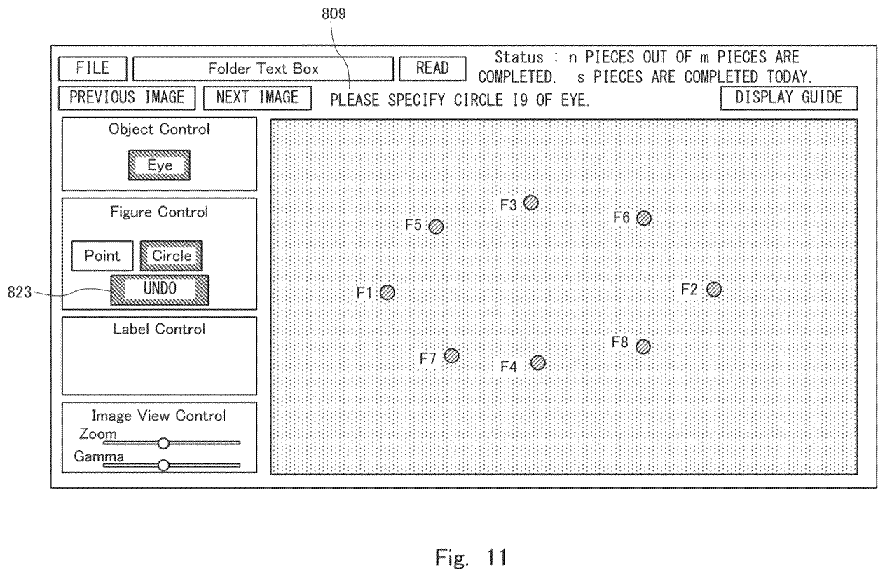

Herein, it is assumed that a user has arranged the circle I9 at an incorrect In this case, a user can cancel the specification operation being input position. immediately before by operating the cancel button 823 for canceling the operation. FIG. 11 illustrates a user interface when a user operates the cancel button 823 and returns to a state before the arrangement of the circle I9 is performed. In this case, since the specification operation for the circle I9 needs to be performed again, a notification that “Please specify a circle I9 of the eye.” is displayed in the work notification area 809.

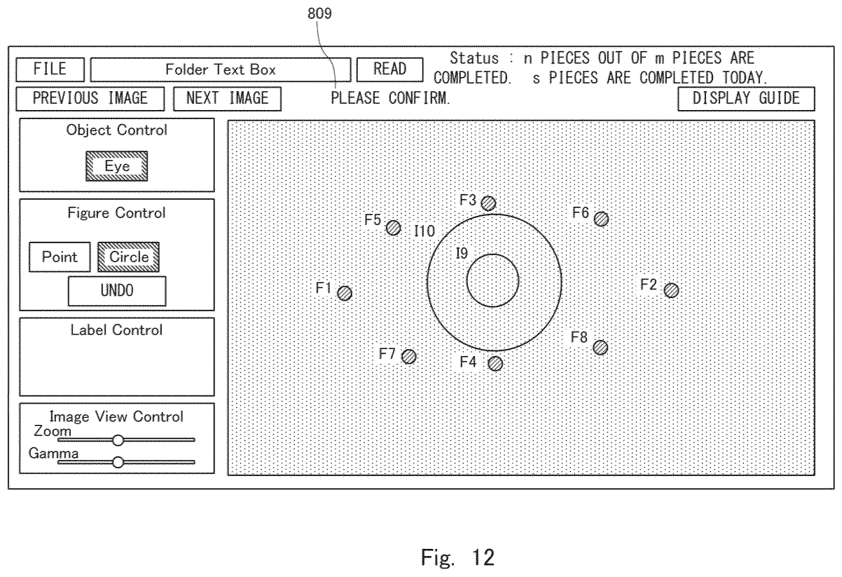

FIG. 12 is a schematic diagram illustrating a user interface at a time point when the specification operation for all the graphic elements defined by the object configuration information is completed. When the specification operation for the element being set in the object configuration information is completed, the user interface unit 105 may accept correction for the specified element. For this reason, in the example illustrated in FIG. 12, the user interface unit 105 displays a notification that “Please confirm.” in the work notification area 809, and also accepts a correction operation by a user. For example, a user corrects a position of a graphic element that has already been arranged by performing a drag operation or the like. Note that, the user interface unit 105 may accept correction of information of an element that has already been input at any timing. As described above, the user interface unit 105 may accept the correction of information of an element specified by an input. Since the user interface unit 105 accepts the correction from a user, the input of the erroneous information can be corrected, and thus convenience is improved.

The first example embodiment has been described above. According to the information processing apparatus 100, a user interface specialized for a work procedure to be performed by a user is provided. For this reason, according to the information processing apparatus 100, it is possible to efficiently add annotation information to an image.

Teacher data used to learn a machine learning model vary depending on a purpose of use of the machine learning model. In other words, a type of an annotation varies depending on the purpose of use of the machine learning model. For this reason, work required for adding annotation information varies depending on the purpose of use of the machine learning model. In general, a user interface for handling various applications includes various UI components. However, the UI components used by a user for one purpose is limited, and not all UI components are used. Use of a user interface in which an unnecessary UI component is arranged reduces work efficiency. In contrast, according to the information processing apparatus 100, a user interface that can be used for various purposes and is specialized for a purpose of a user is provided. For this reason, according to the information processing apparatus 100, it is possible to perform efficient work while coping with various purposes.

### Second Example Embodiment

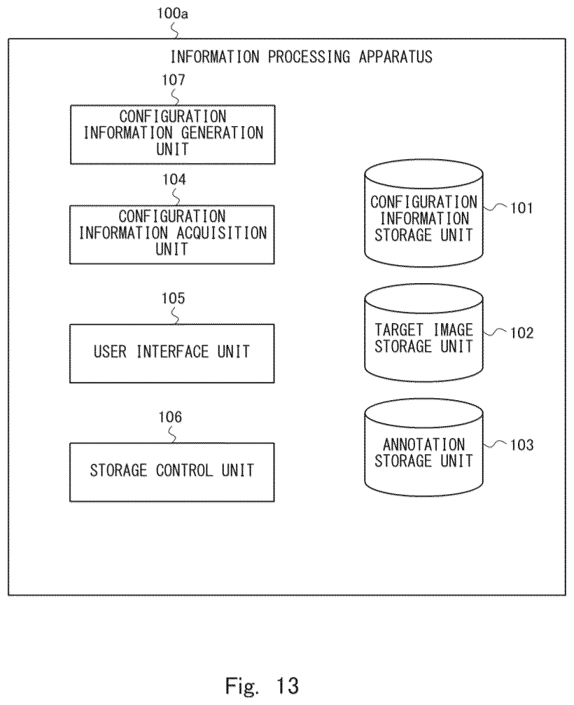

Next, a second example embodiment will be described. The present example embodiment is different from the first example embodiment in that an information processing apparatus further has a function for generating configuration information. FIG. 13 is a block diagram illustrating one example of a functional configuration of an information processing apparatus 100a according to the second example embodiment. The information processing apparatus 100a according to the second example embodiment is different from the information processing apparatus 100 according to the first example embodiment in that the information processing apparatus 100a further includes a configuration information generation unit 107. The configuration information generation unit 107 is achieved by, for example, a processor 154 reading and executing software (a computer program) from a memory 153. Hereinafter, a different point from the first example embodiment will be described in detail, and redundant description will be omitted as appropriate.

The configuration information generation unit 107 generates configuration information, based on an input accepted from a user. The configuration information generation unit 107 may generate only object configuration information, only task configuration information, or both thereof, based on an input by a user. The configuration information generation unit 107 stores the generated configuration information in a configuration information storage unit 101. Therefore, in the present example embodiment, a configuration information acquisition unit 104 acquires the object configuration information generated by the configuration information generation unit 107. Note that, in the present example embodiment as well, the configuration information acquisition unit 104 may acquire configuration information not generated by the configuration information generation unit 107, that is, configuration information acquired from another apparatus. The configuration information generation unit 107 may provide a user interface for deciding a content of the object configuration information or the task configuration information. Further, the user interface may also be a GUI.

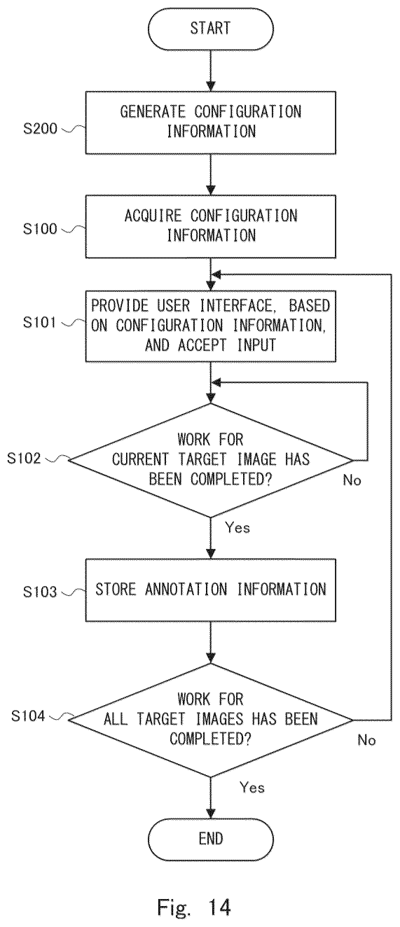

FIG. 14 is a flowchart illustrating one example of operation of the information processing apparatus 100a according to the second example embodiment. The flowchart illustrated in FIG. 14 is different from the flowchart illustrated in FIG. 6 in that step S200 is performed prior to execution of step S100.

In step S200, the configuration information generation unit 107 generates configuration information, based on an input accepted from a user, and stores the generated configuration information in the configuration information storage unit 101. After step S200, the step S100 and subsequent steps described above are executed.

The second example embodiment has been described above. In the present example embodiment, the information processing apparatus 100a further has a function for generating configuration information. For this reason, a user can freely design a configuration of annotation information and a generation task of the annotation information, and thus convenience is further improved.

### Third Example Embodiment

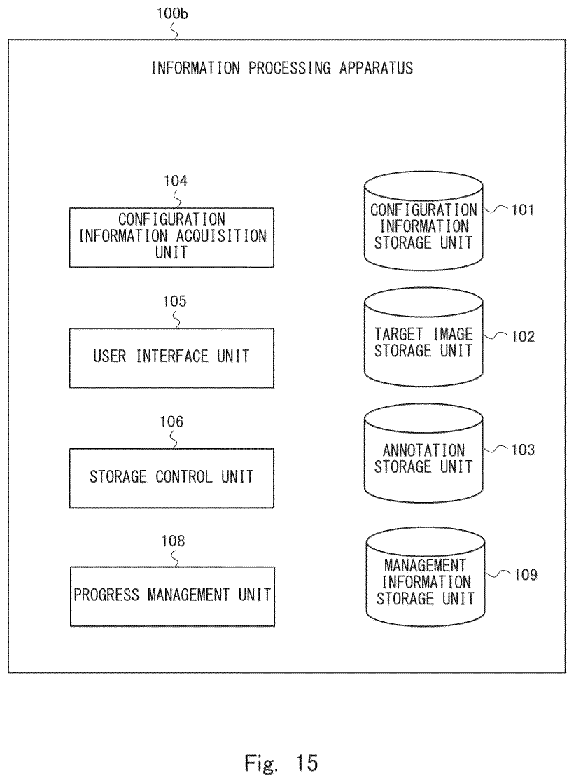

Next, a third example embodiment will be described. The present example embodiment is different from the first example embodiment in that an information processing apparatus manages progress of generation work of annotation information for each user. FIG. 15 is a block diagram illustrating one example of a functional configuration of an information processing apparatus 100b according to the third example embodiment. The information processing apparatus 100b according to the third example embodiment is different from the information processing apparatus 100 according to the first example embodiment in that the information processing apparatus 100b further includes a progress management unit 108 and a management information storage unit 109. The progress management unit 108 is achieved by, for example, a processor 154 reading and executing software (a computer program) from a memory 153. Further, the management information storage unit 109 is achieved by, for example, a storage apparatus 152. Hereinafter, a different point from the first example embodiment will be described in detail, and redundant description will be omitted as appropriate. Note that, features described in the present example embodiment can be combined with features described in the second example embodiment.

The progress management unit 108 manages, for each user, progress of generation work of annotation information by a user. In other words, the progress management unit 108 manages, for each user, the progress of an input for specifying an element with respect to an object included in an image. For example, the progress management unit 108 may manage, for each user, the number of images for which the generation work of the annotation information has been completed during a period from a start time point of work (e.g., a work start time or a work start date) to the present. In other words, the progress management unit 108 may manage, for each user, how many images have been input for specifying an element with respect to an object included in the image during the period from the start time point of the work to the present. Alternatively, the progress management unit 108 may manage, for each user, how much time is required for generation of annotation information for one image. In other words, the progress management unit 108 may manage, for each user, how much time is required for an input for specifying an element of an object included in one image. As described above, the progress management unit 108 manages a work pace for each user.

Note that, the progress management unit 108 may manage the following information. For example, the progress management unit 108 may manage which user is in charge of generating annotation information for which image. Further, the progress management unit 108 may manage the number of operations required to generate annotation information for one image. The progress management unit 108 may output information to be managed as log data.

The progress management unit 108 generates progress management information being information indicating progress status of each user, and stores the generated progress management information in the management information storage unit 109. The management information storage unit 109 stores the progress management information generated by the progress management unit 108. Note that, in the configuration illustrated in FIG. 15, the management information storage unit 109 is included in the information processing apparatus 100b, but the management information storage unit 109 may be achieved by another apparatus communicably connected to the information processing apparatus 100b via a network or the like. Further, the management information storage unit 109 may be configured as a database.

In the present example embodiment, a user interface unit 105 outputs guide information for a user, based on the work pace of the user determined from the progress indicated in the progress management information. For example, the user interface unit 105 may output guide information to a user whose work pace does not satisfy a predetermined criterion regardless of whether a guide display button 808 is operated, that is, regardless of whether there is a request from the user. In contrast, the user interface unit 105 may output guide information to a user whose work pace satisfies the predetermined criterion only when there is a request from the user. Further, the user interface unit 105 may provide, to a user whose work pace does not satisfy the predetermined criterion, guide information having a larger amount of information than guide information for a user whose work pace satisfies the predetermined criterion. Specifically, the user interface unit 105 may provide the following guide information to a user whose work pace does not satisfy the predetermined criterion. For example, the user interface unit 105 may highlight and display an element associated to an element to be arranged next by a user on a target image among each of the elements described in an image (refer to FIG. 8) illustrating an arrangement example of each graphic element. In contrast, the user interface unit 105 may omit such highlighting for a user whose work pace satisfies the predetermined criterion. Further, for example, the user interface unit 105 may provide the guide information by voice to a user whose work pace does not satisfy the predetermined criterion, and may omit providing such guide information by voice to a user whose work pace satisfies the predetermined criterion.

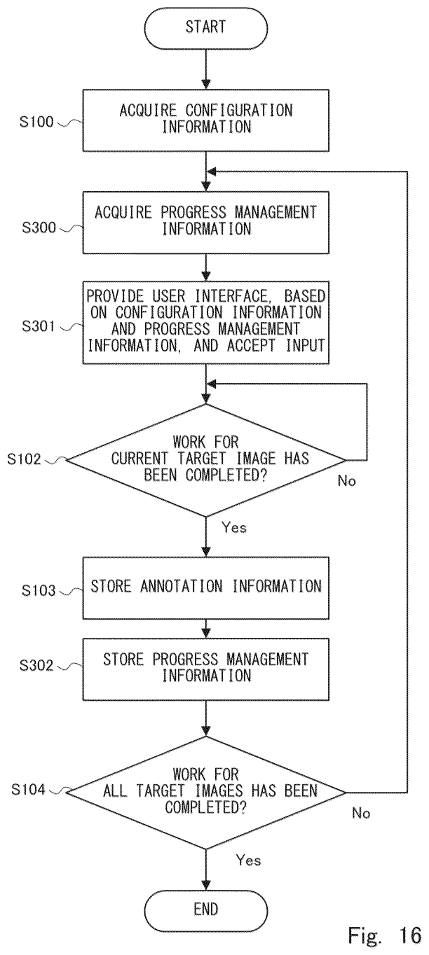

FIG. 16 is a flowchart illustrating one example of operation of the information processing apparatus 100b according to the third example embodiment. The flowchart illustrated in FIG. 16 is different from the flowchart illustrated in FIG. 6 in that step S300 and step S302 are added and step S301 is included in place of step S101.

In the present example embodiment, after step S100, processing proceeds to step S300. However, step S300 may be performed before step S100. In step S300, when progress management information of a user who performs generation work of annotation information is stored in the management information storage unit 109, the user interface unit 105 acquires the progress management information from the management information storage unit 109. Note that, the present step can be skipped when the work by the user is performed for a first time.

In the present example embodiment, after step S300, step S301 is performed in place of step S101. In step S301, the user interface unit 105 outputs guide information according to a work pace of a user determined from the progress indicated in the progress management information, in addition to the processing in step S101 illustrated in FIG. 6. After step S301, the processing proceeds to step S102. Then, in the present example embodiment, after the processing of step S102 and step S103, the processing proceeds to step S302.

The progress management unit 108 monitors an operation by a user on a user interface, and when the processing proceeds to step S302, the progress management unit 108 stores the progress management information with respect to the user in the management information storage unit 109. Note that, when the progress management information with respect to the user is not yet stored in the management information storage unit 109, the progress management unit 108 newly generates the progress management information with respect to the user, and stores the generated progress management information in the management information storage unit 109. In contrast, when the progress management information with respect to the user is already stored in the management information storage unit 109, the progress management unit 108 updates the progress management information with respect to the user in the management information storage unit 109. After step S302, the processing proceeds to step S104. Note that, in the flowchart illustrated in FIG. 16, storing processing (update processing) of the progress management information is performed after step S103, but the storing processing (update processing) may be performed at any timing. For example, after a decision result of Yes is acquired in step S104, the storing processing (update processing) of the progress management information may be performed.

The third example embodiment has been described above. In the present example embodiment, the information processing apparatus 100b manages, for each user, progress of generation work of annotation information, and outputs guide information, based on the progress of a user. For this reason, it is possible to provide appropriate guide information according to a degree of skill of a user.

### Fourth Example Embodiment

Next, a fourth example embodiment will be described. In the first example embodiment, a configuration example in which a user performs generation work of annotation information by using the input apparatus 151 and the output apparatus 150 of the information processing apparatus 100 has been described. However, a user does not necessarily have to use the input apparatus 151 and the output apparatus 150 of the information processing apparatus 100. In particular, in a case where the function of the information processing apparatus 100 is achieved in a server apparatus, an input apparatus and an output apparatus of a client terminal communicably connected to the server apparatus via a network may be used for the generation work of the annotation information. Hereinafter, as the fourth example embodiment, an example embodiment in which the server apparatus and the client apparatus provide a similar function as that of the first example embodiment will be described. Note that, the configuration described below is not limited to the first example embodiment, and can be achieved with respect to the other example embodiments described above.

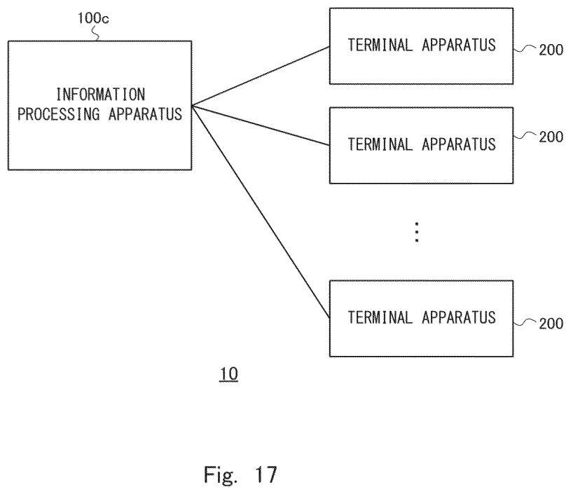

FIG. 17 is a block diagram illustrating one example of a configuration of an information processing system 10 according to the fourth example embodiment. As illustrated in FIG. 17, the information processing system 10 includes an information processing apparatus 100c as a server and one or more terminal apparatuses 200 as clients. The information processing apparatus 100c and the terminal apparatus 200 are communicably connected to each other wiredly or wirelessly. Each of the terminal apparatuses 200 may be used by a different user. Herein, a user of each of the terminal apparatuses 200 may perform generation of annotation information with respect to different objects by using the information processing apparatus 100c. In other words, the information processing apparatus 100c can process various generation tasks of the annotation information. At that time, as described in the above-described example embodiment, the information processing apparatus 100c provides a user interface specialized for each task.

Since a functional configuration of the information processing apparatus 100c is similar to the functional configuration of the information processing apparatus 100 according to the first example embodiment illustrated in FIG. 4, description thereof will be omitted. However, in the present example embodiment, a user interface unit 105 provides a user interface via an output apparatus 150 of the terminal apparatus 200, and accepts an input to the user interface via an input apparatus 151 of the terminal apparatus 200. In other words, in the first example embodiment, the user interface unit 105 also includes functions of an output control unit 201 and an input acceptance unit 202 described below, but in the present example embodiment, these functions are included in the terminal apparatus 200.

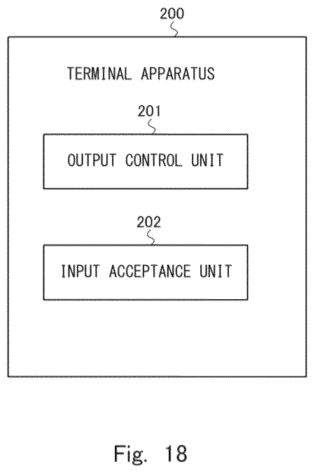

FIG. 18 is a block diagram illustrating one example of a functional configuration of the terminal apparatus 200. As illustrated in FIG. 18, the terminal apparatus 200 includes the output control unit 201 and the input acceptance unit 202.

The output control unit 201 outputs a user interface provided from the information processing apparatus 100c to the output apparatus 150 of the terminal apparatus 200. Further, the input acceptance unit 202 accepts an input from a user to the provided user interface. In other words, the input acceptance unit 202 accepts an input performed in generation work of the annotation information, such as a specification operation of an element. Specifically, the input acceptance unit 202 accepts an input via the input apparatus 151 of the terminal apparatus 200.

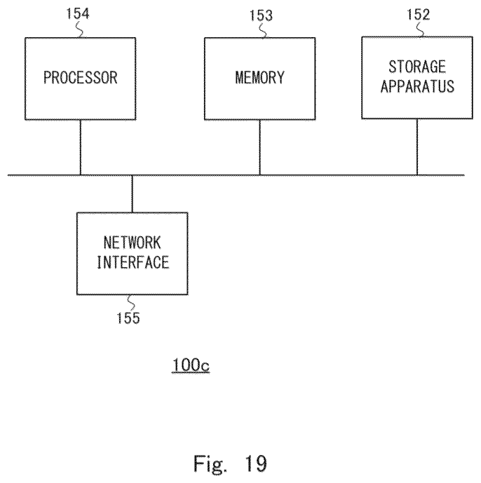

FIG. 19 is a block diagram illustrating one example of a hardware configuration of the information processing apparatus 100c. As illustrated in FIG. 19, the information processing apparatus 100c includes a storage apparatus 152, a memory 153, a processor 154, and a network interface 155. In this way, the information processing apparatus 100c has a function as a computer. The storage apparatus 152, the memory 153, and the processor 154 have already been described, and thus, description thereof will be omitted.

The network interface 155 is used for communicating with another apparatus (specifically, the terminal apparatus 200). The network interface 155 may include, for example, a network interface card (NIC). For example, the user interface unit 105 of the information processing apparatus 100c provides a user interface to the terminal apparatus 200 via the network interface 155.

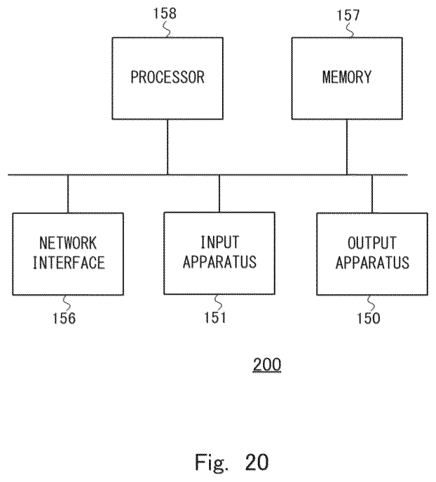

FIG. 20 is a block diagram illustrating one example of a hardware configuration of the terminal apparatus 200. As illustrated in FIG. 20, the terminal apparatus 200 includes a network interface 156, the output apparatus 150, the input apparatus 151, a memory 157, and a processor 158. The output apparatus 150 and the input apparatus 151 illustrated in FIG. 20 are similar to those illustrated in FIG. 5, and thus, description thereof will be omitted.

The network interface 156 is used for communicating with another apparatus (specifically, the information processing apparatus 100c). The network interface 156 may include, for example, a network interface card (NIC). For example, the output control unit 201 of the terminal apparatus 200 accepts provision of a user interface via the network interface 156. Further, the input acceptance unit 202 transmits an input accepted from a user to the information processing apparatus 100c via the network interface 156.

The memory 157 is configured by, for example, a combination of a volatile memory and a non-volatile memory. The memory 157 is used for storing software (a computer program) including one or more instructions to be executed by the processor 158, data used for various pieces of processing of the terminal apparatus 200, and the like.

The processor 158 reads and executes the software (computer program) from the memory 157, and thereby performs processing of the output control unit 201 and the input acceptance unit 202 described above. The processor 158 may be, for example, a microprocessor, a micro processor unit (MPU), a central processing unit (CPU), or the like. The processor 158 may include a plurality of processors.

As described above, the terminal apparatus 200 has a function as a computer.

The fourth example embodiment has been described above. In the present example embodiment, the information processing system 10 including the information processing apparatus 100c as a server and the terminal apparatus 200 as a client can perform generation work of annotation information. For this reason, a user can perform the generation work of the annotation information by preparing the terminal apparatus 200, and thereby convenience is improved.

Although the invention of the present application has been described with reference to the example embodiments, the invention of the present application is not limited to the above. Various modifications that can be understood by a person skilled in the art within the scope of the invention can be made to the configuration and details of the invention of the present application.

Some or all of the above-described example embodiments may also be described as the following supplementary notes, but are not limited thereto.

### (Supplementary Note 1)

An information processing apparatus including:
a configuration information acquisition means for acquiring object configuration information including a definition of each of one or more elements added to an image in order to indicate an object included in the image and a definition of order of the element;
a user interface means for providing a user interface being set based on a definition of the element indicated by the object configuration information according to order of the element defined by the object configuration information, in order to accept an input for specifying the element with respect to the object; and
a storage control means for controlling in such a way as to store information of the element specified by the input in association with the image.

### (Supplementary Note 2)

The information processing apparatus according to supplementary note 1, wherein
the configuration information acquisition means further acquires task configuration information indicating a set of one or more objects, and
the user interface means provides the user interface with reference to the object configuration information of any object included in a set indicated by the task configuration information.

### (Supplementary Note 3)

The information processing apparatus according to supplementary note 2, wherein the user interface means provides the user interface with reference to the object configuration information selected according to an instruction.

### (Supplementary Note 4)

The information processing apparatus according to supplementary note 2, wherein
the task configuration information includes a definition of order of a plurality of objects included in the set, and
the user interface means provides the user interface with reference to the object configuration information selected according to order of the plurality of objects defined in the task configuration information.

### (Supplementary Note 5)

The information processing apparatus according to any one of supplementary notes 1 to 4, wherein
the object configuration information further defines a constraint condition of arrangement of the element on an image, and
the user interface means supports an input for specifying the element, based on the constraint condition.

### (Supplementary Note 6)

The information processing apparatus according to supplementary note 5, wherein the constraint condition restricts a relative relationship of a plurality of the elements on an image.

### (Supplementary Note 7)

The information processing apparatus according to supplementary note 5 or 6, wherein the user interface means outputs a warning when an accepted input does not satisfy the constraint condition.

### (Supplementary Note 8)

The information processing apparatus according to any one of supplementary notes 5 to 7, wherein, when an accepted input does not satisfy the constraint condition, the user interface means corrects a position of the element specified by the input to a position satisfying the constraint condition.

### (Supplementary Note 9)

The information processing apparatus according to any one of supplementary notes 1 to 8, wherein
the object configuration information includes a definition indicating whether the element is essential to be added to an image,
the object configuration information defines order of the element being essential to be added, and
the user interface means sequentially provides a user interface being set based on a definition of the element being essential to be added, according to the order, and provides a user interface associated to a definition of the element not being essential to be added, in response to an instruction to switch a user interface.

### (Supplementary Note 10)

The information processing apparatus according to any one of supplementary notes 1 to 9, wherein the user interface means accepts correction of information of the element specified by the input.

### (Supplementary Note 11)

The information processing apparatus according to any one of supplementary notes 1 to 10, wherein the user interface means outputs guide information guiding an input for specifying the element for the object.

### (Supplementary Note 12)

The information processing apparatus according to supplementary note 11, further including a progress management means for managing, for each user, progress of an input for specifying the element for the object,
wherein the user interface means outputs the guide information for a user, based on a work pace of the user determined from the progress.

### (Supplementary Note 13)

The information processing apparatus according to any one of supplementary notes 1 to 12, further including a configuration information generation means for generating the object configuration information, based on an accepted input,
wherein the configuration information acquisition means acquires the object configuration information generated by the configuration information generation means.

### (Supplementary Note 14)

An information processing system including:
an information processing apparatus; and
a terminal apparatus, wherein
the information processing apparatus includes
a configuration information acquisition means for acquiring object configuration information including a definition of each of one or more elements added to an image in order to indicate an object included in the image and a definition of order of the element,
a user interface means for providing a user interface being set based on a definition of the element indicated by the object configuration information according to order of the element defined by the object configuration information, in order to accept an input for specifying the element with respect to the object, and
a storage control means for controlling in such a way as to store information of the element specified by the input in association with the image, and
the terminal apparatus includes
an output control means for outputting the user interface provided from the information processing apparatus to an output apparatus, and
an input acceptance means for accepting an input to the user interface.

### (Supplementary Note 15)

The information processing system according to supplementary note 14, wherein
the configuration information acquisition means further acquires task configuration information indicating a set of one or more objects, and
the user interface means provides the user interface with reference to the object configuration information of any object included in a set indicated by the task configuration information.

### (Supplementary Note 16)

An information processing method including:
acquiring object configuration information including a definition of each of one or more elements added to an image in order to indicate an object included in the image and a definition of order of the element;
providing a user interface being set based on a definition of the element indicated by the object configuration information according to order of the element defined by the object configuration information, in order to accept an input for specifying the element with respect to the object; and
controlling in such a way as to store information of the element specified by the input in association with the image.

### (Supplementary Note 17)

A non-transitory computer-readable medium storing a program causing a computer to execute
a configuration information acquisition step of acquiring object configuration information including a definition of each of one or more elements added to an image in order to indicate an object included in the image and a definition of order of the element;
a user interface step of providing a user interface being set based on a definition of the element indicated by the object configuration information according to order of the element defined by the object configuration information, in order to accept an input for specifying the element with respect to the object; and
a storage control step of controlling in such a way as to store information of the element specified by the input in association with the image.

### REFERENCE SIGNS LIST

1 INFORMATION PROCESSING APPARATUS
2 CONFIGURATION INFORMATION ACQUISITION UNIT
3 USER INTERFACE UNIT
4 STORAGE CONTROL UNIT
10 INFORMATION PROCESSING SYSTEM
100 INFORMATION PROCESSING APPARATUS
100a INFORMATION PROCESSING APPARATUS
100b INFORMATION PROCESSING APPARATUS
100c INFORMATION PROCESSING APPARATUS
101 CONFIGURATION INFORMATION STORAGE UNIT
102 TARGET IMAGE STORAGE UNIT
103 ANNOTATION STORAGE UNIT
104 CONFIGURATION INFORMATION ACQUISITION UNIT
105 USER INTERFACE UNIT
106 STORAGE CONTROL UNIT
107 CONFIGURATION INFORMATION GENERATION UNIT
108 PROGRESS MANAGEMENT UNIT
109 MANAGEMENT INFORMATION STORAGE UNIT
150 OUTPUT APPARATUS
151 INPUT APPARATUS
152 STORAGE APPARATUS
153 MEMORY
154 PROCESSOR
155 NETWORK INTERFACE
156 NETWORK INTERFACE
157 MEMORY
158 PROCESSOR
200 TERMINAL APPARATUS
201 OUTPUT CONTROL UNIT
202 INPUT ACCEPTANCE UNIT

What is claimed is:

1. An information processing apparatus comprising:
at least one memory storing instructions; and
at least one processor configured to execute the instructions to:
acquire object configuration information including a definition of each of one or more elements added to an image in order to indicate an object included in the image and a definition of order of the element;
provide a user interface being set based on a definition of the element indicated by the object configuration information according to order of the element defined by the object configuration information, in order to accept an input for specifying the element with respect to the object; and
control in such a way as to store information of the element specified by the input in association with the image.

2. The information processing apparatus according to claim 1, wherein the processor is further configured to execute the instructions to:
further acquire task configuration information indicating a set of one or more objects, and
provide the user interface with reference to the object configuration information of any object included in a set indicated by the task configuration information.

3. The information processing apparatus according to claim 2, wherein the processor is further configured to execute the instructions to provide the user interface with reference to the object configuration information selected according to an instruction.

4. The information processing apparatus according to claim 2, wherein
the task configuration information includes a definition of order of a plurality of objects included in the set, and
the processor is further configured to execute the instructions to provide the user interface with reference to the object configuration information selected according to order of the plurality of objects defined in the task configuration information.

5. The information processing apparatus according to claim 1, wherein
the object configuration information further defines a constraint condition of arrangement of the element on an image, and
the processor is further configured to execute the instructions to support an input for specifying the element, based on the constraint condition.

6. The information processing apparatus according to claim 5, wherein the constraint condition restricts a relative relationship of a plurality of the elements on an image.

7. The information processing apparatus according to claim 5, wherein the processor is further configured to execute the instructions to output a warning when an accepted input does not satisfy the constraint condition.

8. The information processing apparatus according to claim 5, wherein, the processor is further configured to execute the instructions to, when an accepted input does not satisfy the constraint condition, correct a position of the element specified by the input to a position satisfying the constraint condition.

9. The information processing apparatus according to claim 1, wherein
the object configuration information includes a definition indicating whether the element is essential to be added to an image,
the object configuration information defines order of the element being essential to be added, and
the processor is further configured to execute the instructions to sequentially provide a user interface being set based on a definition of the element being essential to be added, according to the order, and provide a user interface associated to a definition of the element not being essential to be added, in response to an instruction to switch a user interface.

10. The information processing apparatus according to claim 1, wherein the processor is further configured to execute the instructions to accept correction of information of the element specified by the input.

11. The information processing apparatus according to claim 1, wherein the processor is further configured to execute the instructions to output guide information guiding an input for specifying the element for the object.

12. The information processing apparatus according to claim 11, wherein the processor is further configured to execute the instructions to manage, for each user, progress of an input for specifying the element for the object, and
output the guide information for a user, based on a work pace of the user determined from the progress.

13. The information processing apparatus according to claim 1, wherein the processor is further configured to execute the instructions to generate the object configuration information, based on an accepted input, and
acquire the generated object configuration information.

14-15. (canceled)

16. An information processing method comprising:
acquiring object configuration information including a definition of each of one or more elements added to an image in order to indicate an object included in the image and a definition of order of the element;
providing a user interface being set based on a definition of the element indicated by the object configuration information according to order of the element defined by the object configuration information, in order to accept an input for specifying the element with respect to the object; and
controlling in such a way as to store information of the element specified by the input in association with the image.

17. A non-transitory computer-readable medium storing a program causing a computer to execute:
a configuration information acquisition step of acquiring object configuration information including a definition of each of one or more elements added to an image in order to indicate an object included in the image and a definition of order of the element;
a user interface step of providing a user interface being set based on a definition of the element indicated by the object configuration information according to order of the element defined by the object configuration information, in order to accept an input for specifying the element with respect to the object; and
a storage control step of controlling in such a way as to store information of the element specified by the input in association with the image.
